(19) United States
(12) Patent Application Publication
(10) Pub. No.: US 2026/0174535 A1
(43) Pub. Date: Jun. 25, 2026

(54) ORAL IRRIGATOR

(71) Applicant: Thumbs Up Innovations Technology Co., Ltd., Zhuhai (CN)

(72) Inventors: JIACHENG HUANG, Zhuhai (CN); LILIN XU, Zhuhai (CN); XIU ZOU, Zhuhai (CN)

(21) Appl. No.: 19/014,731

(22) Filed: Jan. 9, 2025

(30) Foreign Application Priority Data
Dec. 24, 2024 (CN) 202423201579.6

(51) Int. Cl. A61C 17/02

(52) U.S. Cl. CPC A61C 17/0205; A61C 17/0202; A61C 17/0211

(57) ABSTRACT

An oral irrigator includes: an oral irrigator main body provided with a water storage cavity and a liquid outlet, a liquid adding mechanism detachably arranged on the oral irrigator main body and provided with a liquid storage cavity, a magnetic attraction mechanism for attracting the liquid adding mechanism with the oral irrigator main body, locking buckles for locking the liquid adding mechanism onto the oral irrigator main body, and release mechanisms for driving the locking buckles to move to release connection between the liquid adding mechanism and the oral irrigator main body when a user operates. When the liquid adding mechanism is assembled to the oral irrigator main body, the liquid storage cavity is in communication with the water storage cavity. The release mechanisms are also configured for driving the locking buckles to return to an initial state when the user releases the operation.

### CROSS-REFERENCE TO RELATED APPLICATIONS

The application claims priority of Chinese patent application CN2024232015796, filed on Dec. 24, 2024, which is incorporated herein by reference in its entireties.

### TECHNICAL FIELD

The present invention relates to the technical field of oral cleaning products, particularly to an oral irrigator.

### BACKGROUND ART

As is well known, oral irrigators use high-pressure pulse water generated by a pump body to flush an oral cavity, in order to remove small food residues and harmful bacteria adhering to teeth or gums. In order to provide deeper and healthier care for teeth, it is necessary to add mouthwash to water in the oral irrigator. For the convenience of users to add mouthwash, the existing oral irrigator will be equipped with a liquid adding device for storing mouthwash, and the mouthwash can be added to a water tank of the oral irrigator during user operation. However, currently, most of the liquid adding devices in the prior art are generally fixed by tightening screws or forcibly assembled on a main unit by snap-fit joints, which require violent disassembly and assembly to install or remove the liquid adding device. This method is prone to damaging a connection structure between the liquid adding device and the main unit of the oral irrigator, resulting in that the liquid adding device is not firmly attached to the main unit, and the liquid adding device assembled again is prone to falling off automatically, thereby affecting the use of the users.

### SUMMARY

The main purpose of the present invention is to provide an oral irrigator for solving the problem that a structure of the installation and disassembly of a liquid adding device on an existing oral irrigator is easily damaged during use, resulting in the liquid adding device being unstable when fixed again.

In order to solve the above technical problem, a technical solution provided in the present invention is as follows.

An oral irrigator includes:
an oral irrigator main body, wherein the oral irrigator main body is provided with with a water storage cavity for storing water and a liquid outlet;
a liquid adding mechanism detachably provided on the oral irrigator main body, wherein the liquid adding mechanism is provided with a liquid storage cavity for storing oral cleaning liquid; when the liquid adding mechanism is assembled to the oral irrigator main body, the liquid storage cavity is in communication with the water storage cavity; and liquid in the liquid storage cavity is configured for transferring the oral cleaning liquid to the water storage cavity when a user operates the liquid adding mechanism or a main unit;
a magnetic attraction mechanism, wherein the magnetic attraction mechanism is configured for attracting the liquid adding mechanism to the oral irrigator main body when the liquid adding mechanism is close to the oral irrigator main body;
locking buckles, wherein the locking buckles are configured for locking the liquid adding mechanism onto the oral irrigator main body; and
release mechanisms, wherein the release mechanisms are configured for driving the locking buckles to move when the user operates, so that the locking buckles release connection between the liquid adding mechanism and the oral irrigator main body; and the release mechanisms are also configured for driving the locking buckles to return to an initial state when the user releases the operation.

Furthermore, the magnetic attraction mechanism includes first magnetic attraction members and second magnetic attraction members. The second magnetic attraction member is attracted with the first magnetic attraction member. The first magnetic attraction member is arranged on the oral irrigator main body, and the second magnetic attraction member is arranged on the liquid adding mechanism.

Furthermore, a first installation groove is defined in the oral irrigator main body for accommodating the liquid adding mechanism. The liquid adding mechanism is placed in the first installation groove when assembled with the oral irrigator main body.

Furthermore, the magnetic attraction mechanism further includes first elastic members arranged on the oral irrigator main body. The first elastic member is configured for pushing the first magnetic attraction member to move when the locking buckle releases the connection between the liquid adding mechanism and the oral irrigator main body. When the first magnetic attraction member moves, the liquid adding mechanism is at least partially pushed out of the first installation groove through the second magnetic attraction member.

Furthermore, the magnetic attraction mechanism further includes a pushing block. The oral irrigator main body is provided with moving cavities and a first passing hole. The moving cavity is used for limiting a position of the pushing block. The first passing hole is in communication with both the moving cavity and the first installation groove. The first magnetic attraction member is arranged on the pushing block. The pushing block is provided with a second installation groove for accommodating the first elastic member. A position limiting convex block is provided on a peripheral side of the pushing block. The position limiting convex block is placed inside the moving cavity. The pushing block is placed in the first passing hole, and the first elastic member is at least partially placed in the second installation groove.

Furthermore, a third installation groove is also defined in the pushing block, and the first magnetic attraction member is provided in the third installation groove.

Furthermore, a second passing hole is defined in the pushing block. An upper end and a lower end of the second passing hole are respectively in communication with the second installation groove and the third installation groove.

Furthermore, fourth installation grooves are defined in the liquid adding mechanism. The second magnetic attraction member is at least partially placed in the fourth installation groove.

Positioning convex blocks are provided on the liquid adding mechanism. The fourth installation groove is positioned in the positioning convex block. A positioning groove is defined in the oral irrigator main body. The first passing hole is positioned in a bottom portion of the positioning groove. The positioning convex block is placed in the positioning groove when the liquid adding mechanism is assembled with the oral irrigator main body.

Furthermore, a total number of the magnetic attraction mechanisms is two, and the two magnetic attraction mechanisms are spaced apart.

Furthermore, the oral irrigator main body is provided with a guiding strip on a side wall of the first installation groove. The guiding strip extends along a direction in which the liquid adding mechanism is installed in the first installation groove. An outer side of the liquid adding mechanism is provided with a guiding groove used in conjunction with the guiding strip. The guiding strip is placed in the guiding groove when the liquid adding mechanism is installed in the first installation groove.

Furthermore, a fifth installation groove is defined in the oral irrigator main body. The locking buckle is rotatably provided on the oral irrigator main body, and the locking buckle is at least partially placed in the fifth installation groove. An engaging block is provided on the locking buckle. A third passing hole is defined in the oral irrigator main body. The third passing hole is in communication with the first installation groove. Locking openings are defined in outer side walls of the liquid adding mechanism. When the locking buckle locks the oral irrigator main body and the liquid adding mechanism, the engaging block passes through the third passing hole and then is placed inside the locking opening.

The release mechanism includes a second elastic member and a pressing member. The pressing member is disposed on the oral irrigator main body. Two ends of the second elastic member respectively abut against a side wall of the fifth installation groove, and the locking buckle. The second elastic member is positioned on one side of the locking buckle away from the pressing member. The locking buckle rotates when the pressing member is pressed, so that the engaging block is disengaged from the locking opening. An avoidance hole for avoiding the pressing member is defined in an outer side wall of the oral irrigator main body.

Furthermore, the release mechanism further includes a third elastic member arranged in the fifth installation groove. A support portion is arranged in the third installation groove. Two ends of the third elastic member respectively abut against the pressing member and the support portion.

Furthermore, two sides of the locking buckle are each provided with a rotating shaft portion. A support shaft hole is defined in the support portion. The rotating shaft portion is placed inside the support shaft hole. The second elastic member is positioned above the rotating shaft portion.

Furthermore, the first installation groove is positioned in a bottom portion of the oral irrigator main body, and a groove opening of the first installation groove faces the bottom portion of the oral irrigator main body. A bottom surface of the engaging block is a guiding surface. The guiding surface is used for providing a guiding effect when the liquid adding mechanism is installed in the first installation groove, so that the locking buckle rotates to drive the engaging block to move along a direction away from the liquid adding mechanism.

Furthermore, a stop block is provided at a bottom portion of the locking buckle. The oral irrigator main body is provided with an abutting block formed below the first passing hole. When in a locked state, the stop block abuts against the abutting block to make the locking buckle stop rotating.

Furthermore, the locking buckles and the release mechanisms are both two in number. Each of the release mechanisms is arranged corresponding to one of the locking buckles. The two locking buckles are opposite and positioned on two sides of the first installation groove.

Furthermore, the oral irrigator main body includes a main unit and a water tank. The water tank is arranged below the main unit. The pump body is arranged inside the main unit. The main unit is internally provided with a circuit board, a battery, and the pump body. The battery and the pump body are electrically connected to the circuit board. The liquid outlet is arranged on the main unit. When the pump body is driven, the pump body pumps liquid in the water storage cavity and sends the liquid out from the liquid outlet. The liquid adding mechanism is detachably arranged at a bottom portion of the water tank through the locking buckle, and the water storage cavity is positioned inside the water tank.

Furthermore, the water tank includes: an outer shell detachably provided on the main unit, an intermediate shell provided on a bottom portion of the outer shell and connected to the outer shell to form the water storage cavity, and a bottom shell provided on a bottom portion of the intermediate shell and connected to the intermediate shell to form a fifth installation groove.

The first installation groove, the third passing hole, and the avoidance hole are all defined in a bottom portion of the bottom shell. When the first magnetic attraction member is attracted with the second magnetic attraction member, the first magnetic attraction member is at least partially positioned on the bottom shell. The pressing member is disposed on the bottom shell.

Furthermore, the intermediate shell includes a front shell and an intermediate bracket. The intermediate bracket is positioned between the front shell and the bottom shell. The front shell is connected to the bottom shell, thereby pressing and fixing the intermediate bracket. The fifth installation groove is surrounded and formed by the intermediate bracket and the bottom shell.

Furthermore, the liquid adding mechanism includes an installation seat and a liquid bottle. The second magnetic attraction member is arranged at a top portion of the installation seat. The installation seat is provided with a sixth installation groove used for installation of the liquid bottle. The installation seat is provided with a liquid adding channel. The liquid adding channel is in communication with the liquid storage cavity. The liquid bottle is at least partially disposed in the sixth installation groove. The liquid storage cavity is positioned in the liquid bottle. The liquid bottle is equipped with a blocking member for blocking the liquid storage cavity from the liquid adding channel. The liquid adding channel is in communication with the liquid storage cavity when the blocking member is subjected to an external force.

The present invention has the following beneficial effects. Compared with the prior art, in the present invention, by configuring the liquid adding mechanism, it is convenient for the user to add the oral cleaning liquid into the water storage cavity, so that the liquid in the water storage cavity has a function of cleaning an oral cavity. Furthermore, by configuring the locking buckle, the liquid adding mechanism can be locked onto the oral irrigator main body when the liquid adding mechanism is assembled on the oral irrigator main body, allowing the user to directly add the oral cleaning liquid to the water storage cavity through the liquid adding mechanism during use. Additionally, by configuring the release mechanism, the locking buckle can release the liquid adding mechanism from the oral irrigator main body when the user operates the release mechanism, allowing the user to remove the liquid adding mechanism without damaging the locking buckle. Furthermore, by configuring the magnetic attraction mechanism, the liquid adding mechanism can be prevented from falling off when the locking buckle releases the liquid adding mechanism from the oral irrigator main body, thereby protecting the liquid adding mechanism. When the liquid adding mechanism is close to the oral irrigator main body, the liquid adding mechanism can be attracted to the oral irrigator main body, which can increase the stability of the connection between the liquid adding mechanism and the oral irrigator main body.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic diagram of a state when the present invention is used in conjunction with a nozzle.

FIG. 2 is a partially exploded view of the present invention.

FIG. 3 is an exploded view of a main unit of the present invention.

FIG. 4 is a partially exploded view of a water tank of the present invention.

FIG. 5 is an exploded view of an outer shell and a cover of the present invention.

FIG. 6 is an exploded view of a water tank of the present invention after an outer shell is removed.

FIG. 7 is an exploded view of a water tank of the present invention from another angle of view after an outer shell is removed.

FIG. 8 is a structural diagram of a locking buckle of the present invention.

FIG. 9 is a structural diagram of a bottom shell of the present invention.

FIG. 10 is a schematic diagram of assembly of a release mechanism, a locking buckle, and a bottom shell of the present invention.

FIG. 11 is an enlarged view of area a in FIG. 10.

FIG. 12 is a sectional view of assembly of a bottom shell, an intermediate bracket, a magnetic attraction mechanism, and a liquid adding mechanism of the present invention and cutting along a central axis of a liquid adding channel.

FIG. 13 is an enlarged view of area b in FIG. 12.

FIG. 14 is a perspective view of a liquid adding mechanism of the present invention.

FIG. 15 is an exploded view of a liquid adding mechanism of the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

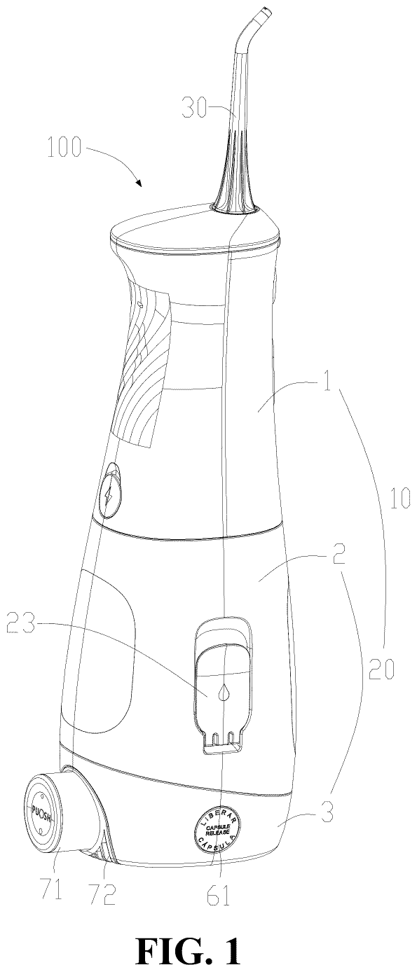

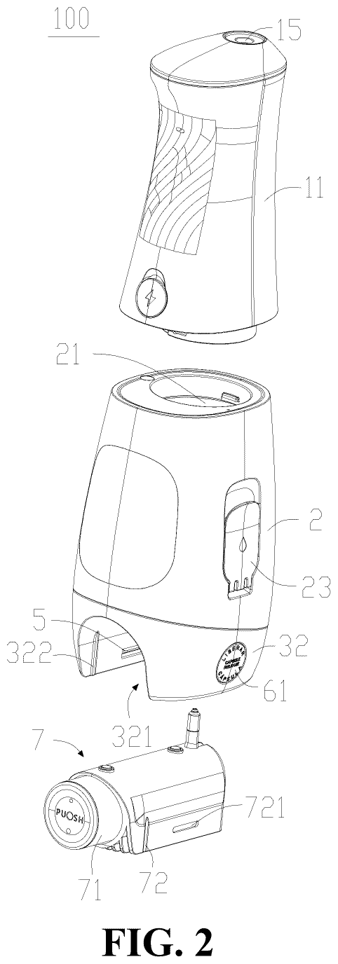

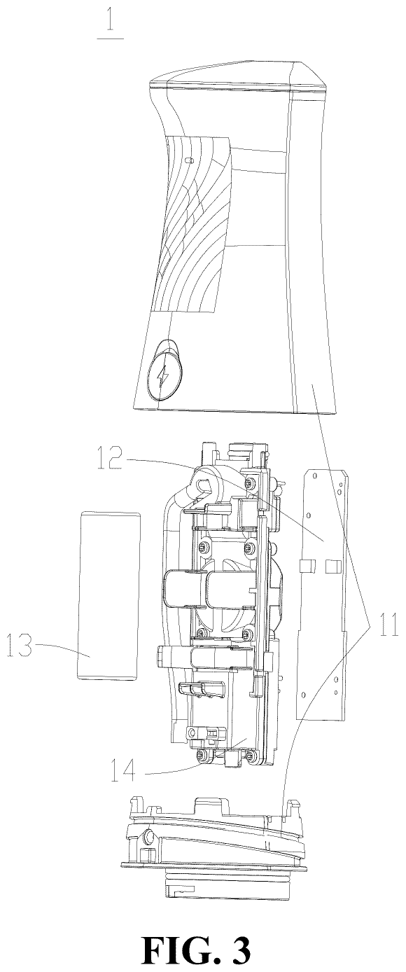

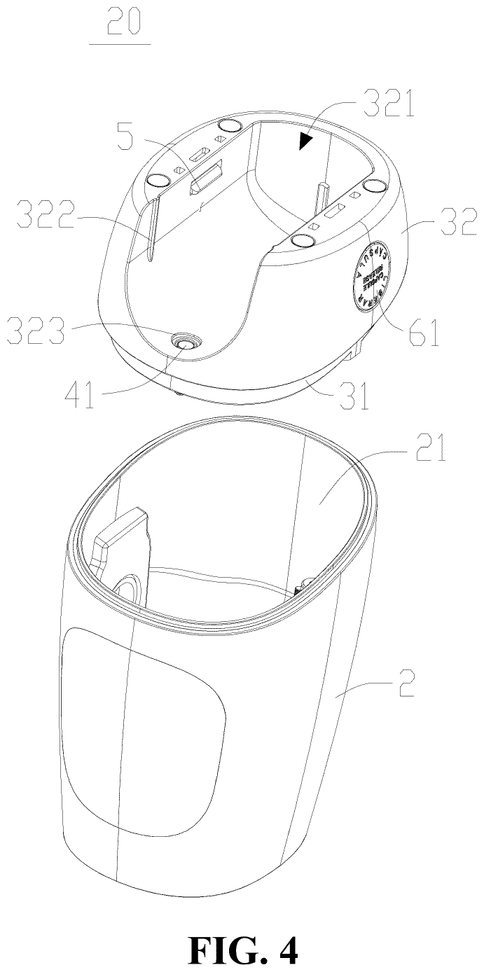

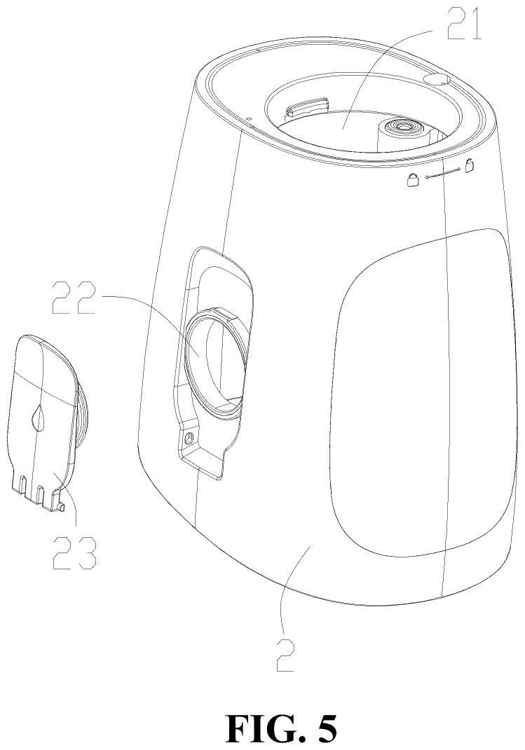

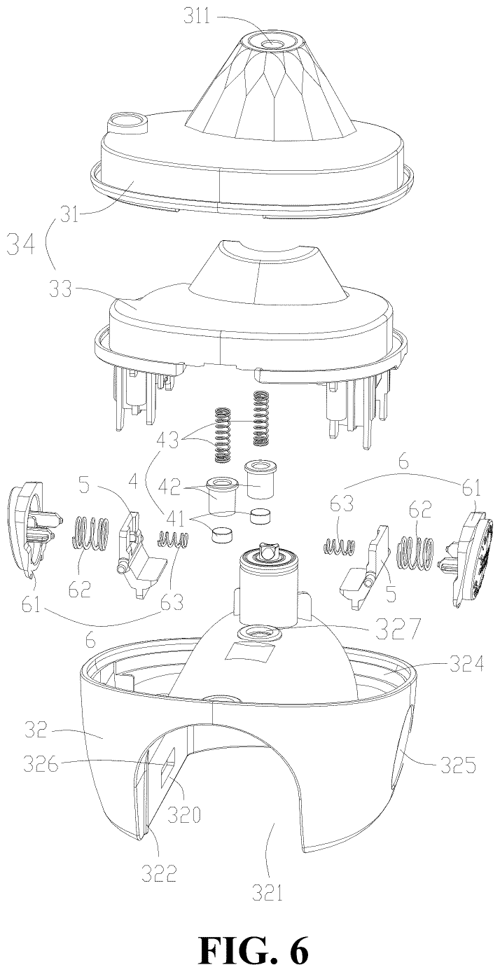

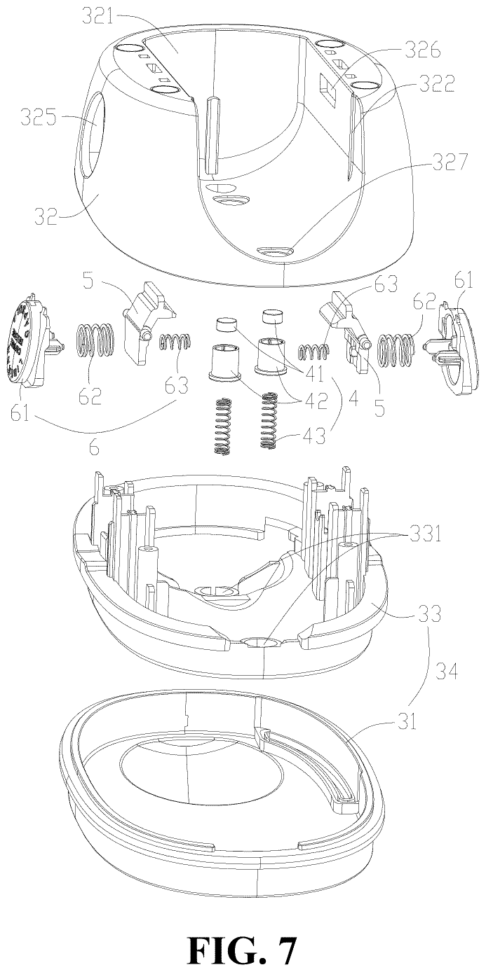

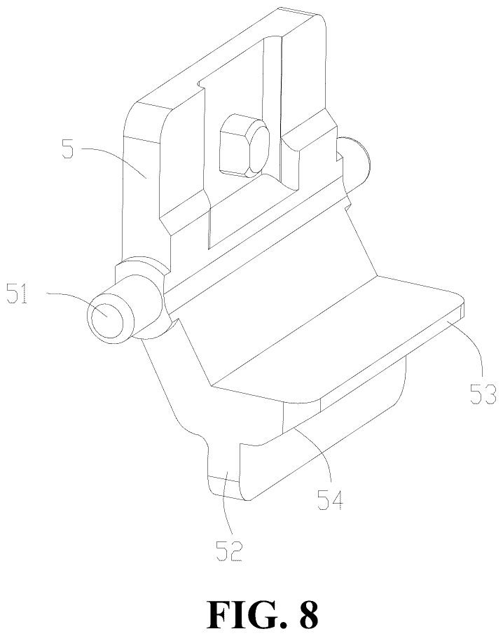

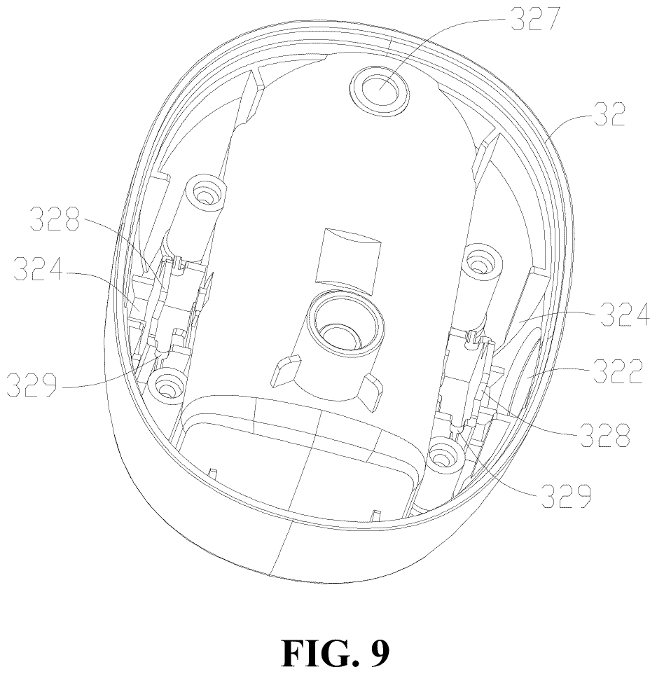

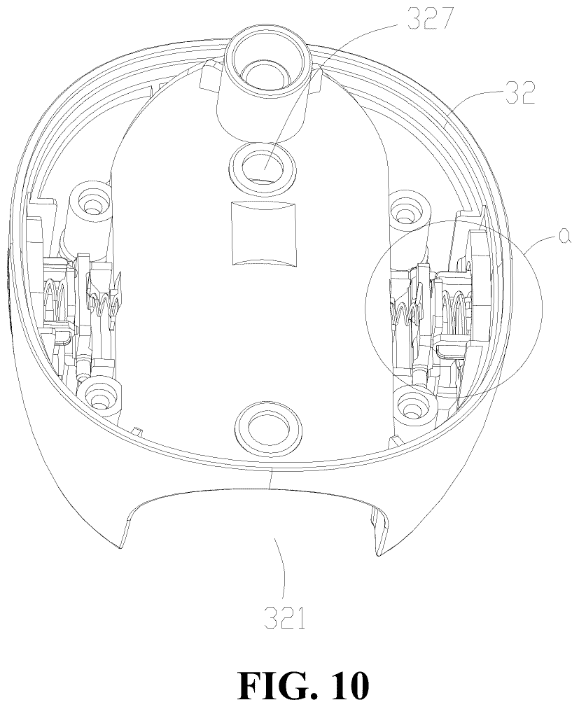

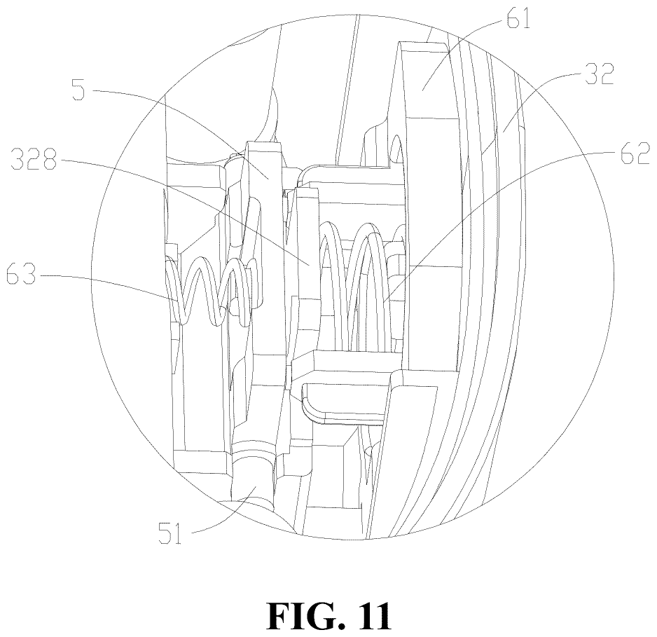

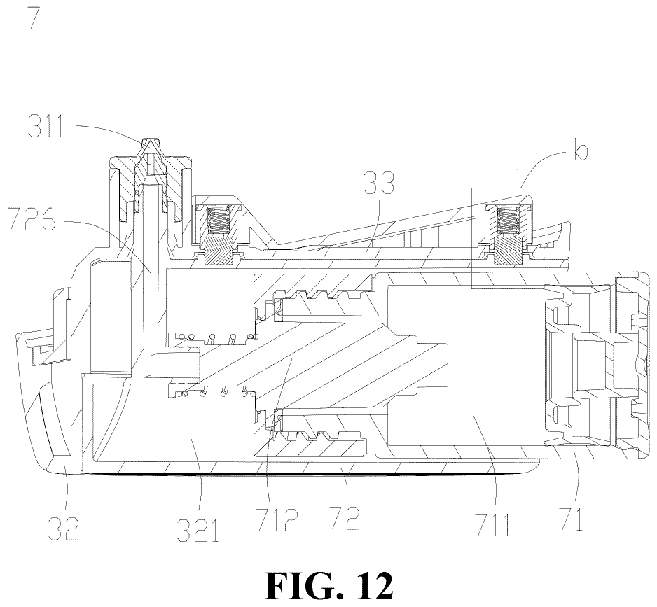

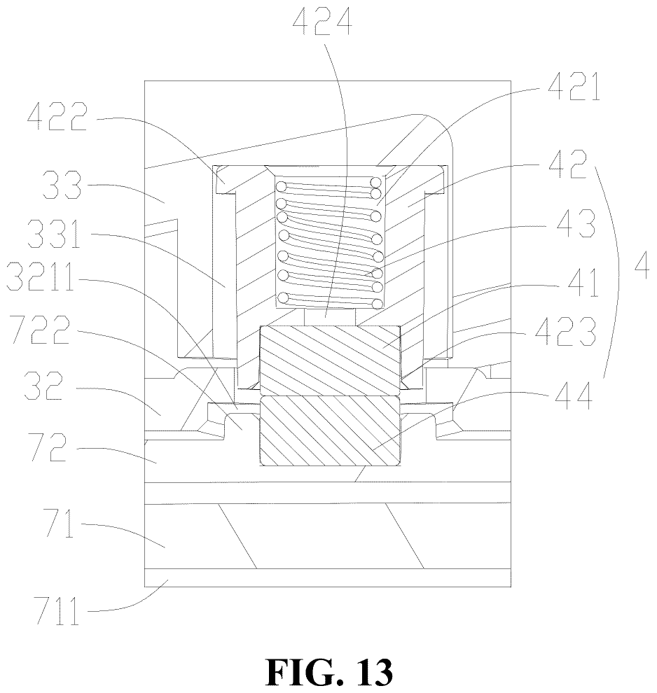

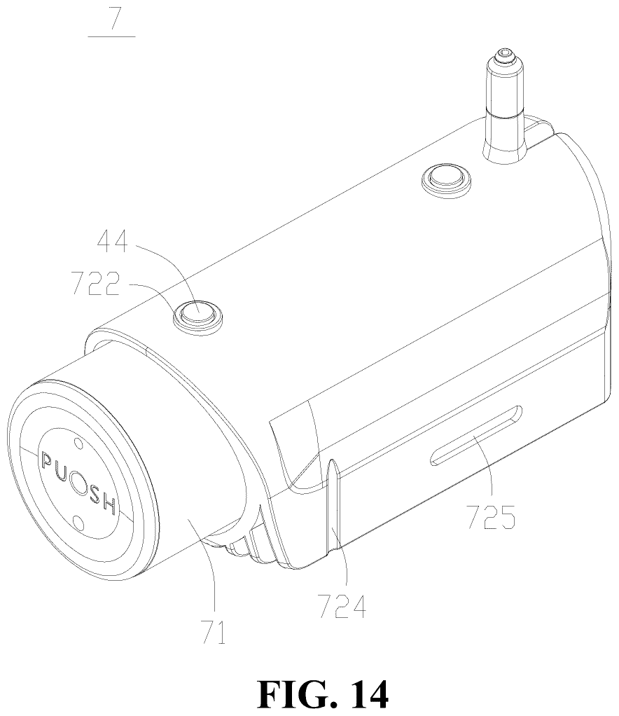

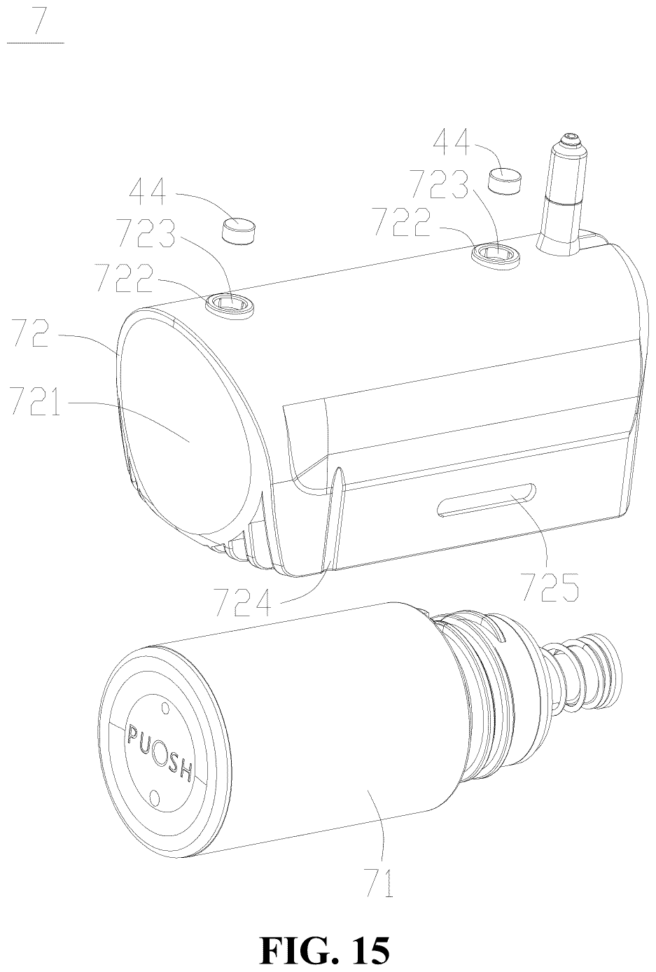

FIGS. 1-15 shows an oral irrigator 100 in an embodiment of the present invention.

The oral irrigator 100 includes:
an oral irrigator main body 10, wherein the oral irrigator main body 10 is provided with a water storage cavity 21 for storing water and a liquid outlet 15;
a liquid adding mechanism 7 detachably provided on the oral irrigator main body 10, wherein the liquid adding mechanism 7 is provided with a liquid storage cavity 711 for storing oral cleaning liquid; when the liquid adding mechanism 7 is assembled to the oral irrigator main body 10, the liquid storage cavity 711 is in communication with the water storage cavity 21; and liquid in the liquid storage cavity 711 is configured for transferring the oral cleaning liquid to the water storage cavity 21 when a user operates the liquid adding mechanism 7 or a main unit;
a magnetic attraction mechanism 4, wherein the magnetic attraction mechanism 4 is configured for attracting the liquid adding mechanism 7 to the oral irrigator main body 10 when the liquid adding mechanism 7 is close to the oral irrigator main body 10;
locking buckles 5, wherein the locking buckles 5 are configured for locking the liquid adding mechanism 7 onto the oral irrigator main body 10; and
release mechanisms 6, wherein the release mechanisms 6 are configured for driving the locking buckles 5 to move when the user operates, so that the locking buckles 5 release connection between the liquid adding mechanism 7 and the oral irrigator main body 10; and the release mechanisms 6 are also configured for driving the locking buckles 5 to return to an initial state when the user releases the operation.

In this embodiment, by configuring the liquid adding mechanism 7, it is convenient for the user to add the oral cleaning liquid into the water storage cavity 21, so that the liquid in the water storage cavity 21 has a function of cleaning an oral cavity. Furthermore, by configuring the locking buckle 5, the liquid adding mechanism 7 can be locked onto the oral irrigator main body 10 when the liquid adding mechanism 7 is assembled on the oral irrigator main body 10, allowing the user to directly add the oral cleaning liquid to the water storage cavity 21 through the liquid adding mechanism 7 during use. Additionally, by configuring the release mechanism 6, the locking buckle 5 can release the liquid adding mechanism 7 from the oral irrigator main body 10 when the user operates the release mechanism 6, allowing the user to remove the liquid adding mechanism 7 from the oral irrigator main body 10 without damaging the locking buckle 5. This solves the problem of connection structure damage caused by violent disassembly between an existing liquid adding device and an existing oral irrigator main unit, and the problem of unstable reinstallation between the existing liquid adding device and the existing oral irrigator main unit. Furthermore, by configuring the magnetic attraction mechanism 4, the liquid adding mechanism 7 can be prevented from falling off when the locking buckle 5 releases the liquid adding mechanism 7 from the oral irrigator main body 10, thereby protecting the liquid adding mechanism 7. When the liquid adding mechanism 7 is close to the oral irrigator main body 10, the liquid adding mechanism 7 can be attracted to the oral irrigator main body 10, which can increase the stability of the connection between the liquid adding mechanism 7 and the oral irrigator main body 10.

Specifically, the oral irrigator 100 further includes a pump body 14. The pump body 14 is used for pumping liquid in the water storage cavity 21 when driven and sending the liquid out from the liquid outlet 15 to form a water flow with a certain pressure, achieving a purpose of rinsing teeth.

In one embodiment, the pump body 14 and the liquid outlet 15 are provided on the oral irrigator main body 10, and the liquid outlet 15 can be directly adapted to different nozzles 30 for the user to rinse and clean teeth. The oral irrigator with this structure is a portable oral irrigator that is convenient for the user to hold and use. Of course, in other embodiments, the pump body 14 and the liquid outlet 15 are also provided on the oral irrigator main body 10, but the oral irrigator 100 further includes a handle, and the liquid outlet 15 is connected to the handle through a hose. Different nozzles are configured on the handle, which constitutes a household oral irrigator. The water storage cavity 21 of this oral irrigator has a large water storage capacity. When in use, the user takes the handle, and the pump body 14 pumps liquid in the water storage cavity 21 when driven, and then sends the liquid out from the nozzle through the liquid outlet 15, the hose, and the handle in sequence to form a water flow with a certain pressure, achieving the purpose of rinsing teeth.

The magnetic attraction mechanism 4 includes first magnetic attraction members 41 and second magnetic attraction members 44. The second magnetic attraction member 44 is attracted with the first magnetic attraction member 41. The first magnetic attraction member 41 is arranged on the oral irrigator main body 10, and the second magnetic attraction member 44 is arranged on the liquid adding mechanism 7. Specifically, both the first magnetic attraction member 41 and the second magnetic attraction member 44 are permanent magnets or magnetizable elements; alternatively, one of the first magnetic attraction member 41 and the second magnetic attraction member 44 may be a magnet, and the other of the first magnetic attraction member 41 and the second magnetic attraction member 44 may be a metal member attracted with the magnet. The metal member may be an iron block, an iron sheet, or an alloy made of iron, nickel, or other materials. In the optimal embodiment, both the first magnetic attraction member 41 and the second magnetic attraction member 44 are neodymium iron boron magnets.

In one embodiment, a first installation groove 321 is defined in the oral irrigator main body 10 for accommodating the liquid adding mechanism 7. The liquid adding mechanism 7 is placed in the first installation groove 321 when assembled with the oral irrigator main body 10. By utilizing the first installation groove 321, the stability of the liquid adding mechanism 7 and the oral irrigator main body 10 during assembly can be improved.

In one embodiment, the magnetic attraction mechanism 4 further includes first elastic members 43 arranged on the oral irrigator main body 10. The first elastic member 43 is configured for pushing the first magnetic attraction member 41 to move when the locking buckle 5 releases the connection between the liquid adding mechanism 7 and the oral irrigator main body 10. When the first magnetic attraction member 41 moves, the liquid adding mechanism 7 is at least partially pushed out of the first installation groove 321 through the second magnetic attraction member 44. When the user needs to remove the liquid adding mechanism 7 from the oral irrigator main body 10, the release mechanism 6 is operated to drive the locking buckle 5 to move to release the connection between the liquid adding mechanism 7 and the oral irrigator main body 10, and under the action of the first elastic member 43, at least one part of the liquid adding mechanism 7 can be pushed out of the first installation groove 321. In this state, it can effectively facilitate the user to remove the liquid adding mechanism 7 from the first installation groove 321. Specifically, the first elastic member 43 can be a spring or an elastic sheet, etc.

In the above embodiment, the magnetic attraction mechanism 4 may further include a pushing block 42. The oral irrigator main body 10 is provided with moving cavities 331 and a first passing hole 327. The moving cavity 331 is used for limiting a position of the pushing block 42. The first passing hole 327 is in communication with both the moving cavity 331 and the first installation groove 321. The first magnetic attraction member 41 is arranged on the pushing block 42. The pushing block 42 is provided with a second installation groove 421 for accommodating the first elastic member 43. A position limiting convex block 422 is provided on a peripheral side of the pushing block 42, the position limiting convex block 422 is placed inside the moving cavity 331, and a width of the first passing hole 327 is smaller than a width of the moving cavity 331, so that the position limiting convex block 422 can be limited inside the moving cavity 331 to limit and install the pushing block 42 on the oral irrigator main body 10. The pushing block 42 is placed in the first passing hole 327, and the first elastic member 43 is at least partially placed in the second installation groove 421. When the second magnetic attraction member 44 in the liquid adding mechanism 7 is attracted with the first magnetic attraction member 41, and the locking buckle 5 locks the liquid adding mechanism 7 onto the oral irrigator main body 10, the first elastic member 43 is compressed and placed in the moving cavity 331. When the locking buckle 5 releases the connection between the oral irrigator main body 10 and the liquid adding mechanism 7, without the position limiting effect of the locking buckle 5, the first elastic member 43 drives the first magnetic attraction member 41 to move along a direction away from the moving cavity 331 through the pushing block 42 under a restoration force, that is, the first magnetic attraction member 41 is pushed into the first installation groove 321, so that the liquid adding mechanism 7 is at least partially pushed out of the first installation groove 321. When the first installation groove 321 is defined in a bottom portion of the oral irrigator main body 10, and under an attraction effect of the first magnetic attraction member 41 and the second magnetic attraction member 44, the liquid adding mechanism 7 will not fall directly from the bottom portion of the oral irrigator main body 10. Moreover, by configuring the pushing block 42, the structure of the magnetic attraction mechanism 4 can be made more compact, so that the first elastic member 43 can push out the first magnetic attraction member 41 along a depth direction of the moving cavity 331, improving the stability of the movement of the first magnetic attraction member 41.

In one embodiment, a third installation groove 423 is also defined in the pushing block 42, and the first magnetic attraction member 41 is provided in the third installation groove 423, so as to increase the stability of the connection between the first magnetic attraction member 41 and the pushing block 42, thereby making the connection between the first magnetic attraction member 41 and the pushing block 42 more stable. Moreover, when the first magnetic attraction member 41 is completely embedded in the third installation groove 423, that is, when the first magnetic attraction member 41 is attracted with the second magnetic attraction member 44, the pushing block 42 can also abut against the liquid adding mechanism 7, which can increase a contact area between the magnetic attraction mechanism 4 and the liquid adding mechanism 7. Therefore, the first elastic member 43 can directly push the liquid adding mechanism 7 out of the first installation groove 321 through the pushing block 42, thereby increasing the strength of pushing the liquid adding mechanism 7 out of the first installation groove 321.

Of course, in other embodiments, the first magnetic attraction member 41 can also be directly placed on a surface of the pushing block 42.

In one embodiment, a second passing hole 424 is defined in the pushing block 42. An upper end and a lower end of the second passing hole 424 are respectively in communication with the second installation groove 421 and the third installation groove 423. Specifically, when a size of the third installation groove 423 is adapted to an outer shape of the first magnetic attraction member 41, the second passing hole 424 can be used to provided an effect of discharging air when the first magnetic attraction member 41 is assembled into the third installation groove 423, so as to install the first magnetic attraction member 41 into the third installation groove 423.

In one embodiment, in order to improve the stability of the connection between the second magnetic attraction member 44 and the liquid adding mechanism 7, fourth installation grooves 723 are defined in the liquid adding mechanism 7. The second magnetic attraction member 44 is at least partially placed in the fourth installation groove 723.

In one embodiment, positioning convex blocks 722 are provided on the liquid adding mechanism 7. The fourth installation groove 723 is positioned in the positioning convex block 722. A positioning groove 3211 is defined in the oral irrigator main body 10. The first passing hole 327 is positioned in a bottom portion of the positioning groove 3211. The positioning convex block 722 is placed in the positioning groove 3211 when the liquid adding mechanism 7 is assembled with the oral irrigator main body 10, so as to assemble the liquid adding mechanism 7 with the oral irrigator main body 10 in an aligned manner.

In one embodiment, a total number of the magnetic attraction mechanisms 4 is two, and the two magnetic attraction mechanisms 4 are spaced apart, so that when the locking buckle 5 releases the connection between the liquid adding mechanism 7 and the oral irrigator main body 10, the liquid adding mechanism 7 can be more stably attracted to the oral irrigator main body 10, and the user can remove the liquid adding mechanism 7 from the oral irrigator main body 10 when overcoming the attraction force of the first magnetic attraction member 41 and the second magnetic attraction member 44. Of course, in other embodiments, the total number of the magnetic attraction mechanisms 4 can also be three, four, etc., and the total number of the magnetic attraction mechanisms 4 is not limited here.

In one embodiment, the oral irrigator main body 10 is provided with a guiding strip 322 on a side wall of the first installation groove 321. The guiding strip 322 extends along a direction in which the liquid adding mechanism 7 is installed in the first installation groove 321. An outer side of the liquid adding mechanism 7 is provided with a guiding groove 724 used in conjunction with the guiding strip 322. The guiding strip 322 is placed in the guiding groove 724 when the liquid adding mechanism 7 is installed in the first installation groove 321. By using the guiding strip 322 in conjunction with the guiding groove 724, a relative position between the liquid adding mechanism 7 and the oral irrigator main body 10 can be limited, and the stability of the connection between the liquid adding mechanism 7 and the oral irrigator main body 10 can be improved. With the help of the pushing block 42 and the first elastic member 43, the liquid adding mechanism 7 can be pushed out along a length direction of the guiding strip 322, thereby improving the stability of the relative movement between the liquid adding mechanism 7 and the oral irrigator main body 10. Specifically, a total number of the guiding strips 322 is equal to a total number of the guiding grooves 724, and the total number of the guiding strips 322 can be one, two, four, etc.

In one embodiment, a fifth installation groove 324 is defined in the oral irrigator main body 10. The locking buckle 5 is rotatably provided on the oral irrigator main body 10, and the locking buckle 5 is at least partially placed in the fifth installation groove 324. An engaging block 53 is provided on the locking buckle 5. A third passing hole 326 is defined in the oral irrigator main body 10. The third passing hole 326 is in communication with the first installation groove 321. Locking openings 725 are defined in outer side walls of the liquid adding mechanism 7. When the locking buckle 5 locks the oral irrigator main body 10 and the liquid adding mechanism 7, the engaging block 53 passes through the third passing hole 326 and then is placed inside the locking opening 725 to lock the liquid adding mechanism 7 on the oral irrigator main body 10.

The release mechanism 6 includes a second elastic member 63 and a pressing member 61. The pressing member 61 is disposed on the oral irrigator main body 10. Two ends of the second elastic member 63 respectively abut against a side wall of the fifth installation groove 324, and the locking buckle 5. The second elastic member 63 is positioned on one side of the locking buckle 5 away from the pressing member 61. The locking buckle 5 rotates when the pressing member 61 is pressed, so that the engaging block 53 is disengaged from the locking opening 725, that is, the locking buckle 5 exits from the locking opening 725. In this state, the second elastic member 63 is compressed. Moreover, when the user releases the pressing member 61, the restoration force of the second elastic member 63 can drive the locking buckle 5 and the pressing member 61 to return to an initial position. An avoidance hole 325 for avoiding the pressing member 61 is defined in an outer side wall of the oral irrigator main body 10. That is, through the avoidance hole 325, the pressing member 61 can be displayed on the outer side wall of the oral irrigator main body 10 for user operation.

In the above embodiment, the release mechanism 6 further includes a third elastic member 62 arranged in the fifth installation groove 324. A support portion 328 is arranged in the third installation groove 423. Two ends of the third elastic member 62 respectively abut against the pressing member 61 and the support portion 328, that is, the third elastic member 62 is positioned between the pressing member 61 and the support portion 328. By using the third elastic member 62, after the user presses the pressing member 61, the pressing member 61 can be driven to return to the initial position, so as to reduce a weight of a load when the second elastic member 63 is restored, so that all the elastic force of the second elastic member 63 acts on the locking buckle 5, thereby increasing the service life of the second elastic member 63.

In one embodiment, two sides of the locking buckle 5 are each provided with a rotating shaft portion 51. A support shaft hole 329 is defined in the support portion 328. The rotating shaft portion 51 is placed inside the support shaft hole 329 to achieve the rotational connection of the locking buckle 5. The second elastic member 63 is positioned above the rotating shaft portion 51, that is, the second elastic member 63 and the engaging block 53 are respectively positioned at two ends of the locking buckle 5 or at positions near the two ends of the locking buckle 5. In this way, after the locking buckle 5 rotates under the pressing action of the pressing member 61, a first end of the locking buckle 5 is pushed to move towards a direction of the pressing member 61 by using the second elastic member 63, so that the engaging block 53 on a second end of the locking buckle 5 moves along a direction away from the pressing member 61, thereby allowing the engaging block 53 to be placed in the first installation groove 321. That is, when the liquid adding mechanism 7 is assembled to the oral irrigator main body 10, the engaging block 53 is placed in the locking opening 725 to lock the liquid adding mechanism 7. Specifically, both the second elastic member 63 and the third elastic member 62 can be springs or elastic sheets.

In one embodiment, the first installation groove 321 is positioned in a bottom portion of the oral irrigator main body 10, and a groove opening of the first installation groove 321 faces the bottom portion of the oral irrigator main body 10. A bottom surface of the engaging block 53 is a guiding surface 54. The guiding surface 54 is used for providing a guiding effect when the liquid adding mechanism 7 is installed in the first installation groove 321, so that the locking buckle 5 rotates to drive the engaging block 53 to move along a direction away from the liquid adding mechanism 7. That is, when the liquid adding mechanism 7 is installed in the first installation groove 321, the user does not need to operate the release mechanism 6. Under the compression of the liquid adding mechanism 7, the locking buckle 5 rotates, causing the engaging block 53 to move along the direction away from the liquid adding mechanism 7. Moreover, when the locking opening 725 is opposite to the engaging block 53, the locking buckle 5 is restored to the initial position under the restoration action of the second elastic member 63, that is, the engaging block 53 is placed in the locking opening 725 to lock the liquid adding mechanism 7 on the oral irrigator main body 10. Specifically, the guiding surface 54 can be a curved surface, an inclined surface, or a combination of the curved surface and the inclined surface.

In one embodiment, a stop block 52 is provided at a bottom portion of the locking buckle 5. The oral irrigator main body 10 is provided with an abutting block 320 formed below the first passing hole 327. When in a locked state, the stop block 52 abuts against the abutting block 320 to make the locking buckle 5 stop rotating, thereby limiting the initial position of the locking buckle 5.

In one embodiment, the locking buckles 5 and the release mechanisms 6 are both two in number. Each of the release mechanisms 6 is arranged corresponding to one of the locking buckles 5. The two locking buckles 5 are opposite and positioned on two sides of the first installation groove 321, and cooperate with the locking openings 725 respectively positioned on two sides of the liquid adding mechanism 7, so that the liquid adding mechanism 7 can be locked from two opposite sides, thereby effectively improving the stability of the connection between the oral irrigator main body 10 and the liquid adding mechanism 7. Of course, in other embodiments, a total number of the locking buckles 5 can also be three, four, etc., and one release mechanism 6 can correspondingly drive one or more locking buckles 5 to rotate simultaneously.

In one embodiment, the oral irrigator main body 10 includes a main unit 1 and a water tank 20. The water tank 20 is arranged below the main unit 1. The pump body 14 is arranged inside the main unit 1. The main unit 1 is also internally provided with a circuit board 12 electrically connected to the pump body 14 and a battery 13 electrically connected to the circuit board 12. The liquid outlet 15 is arranged on the main unit 1. The water storage cavity 21 is positioned inside the water tank 20, and the liquid adding mechanism 7 is detachably arranged at a bottom portion of the water tank 20 through the locking buckle 5, that is, the first installation groove 321, the locking buckle 5, and the release mechanism 6 are all provided on the water tank 20.

In one embodiment, for the convenience of production and manufacturing of the water tank 20, the water tank 20 includes: an outer shell 2 detachably provided on the main unit 1, an intermediate shell 34 provided on a bottom portion of the outer shell 2 and connected to the outer shell 2 to form the water storage cavity 21, and a bottom shell 32 provided on a bottom portion of the intermediate shell 34 and connected to the intermediate shell 34 to form the fifth installation groove 324. The first installation groove 321, the third passing hole 326, the first passing hole 327, and the avoidance hole 325 are all defined in a bottom portion of the bottom shell 32. When the first magnetic attraction member 41 is attracted with the second magnetic attraction member 44, the first magnetic attraction member 41 is at least partially positioned on the bottom shell 32. The pressing member 61 is disposed on the bottom shell 32. Moreover, by using the intermediate shell 34 in conjunction with the bottom shell 32, the moving cavity 331 for limiting a position of the pushing block 42 can also be formed. The outer shell 2 can be fixed to the main unit 1 in the form of threads or buckles, and the outer shell 2 is provided with a water inlet 22 in communication with the water storage cavity 21. The outer shell 2 is equipped with a cover 23 at a position corresponding to the water inlet 22. Through the water inlet 22, it is convenient for the user to add liquid to the water storage cavity 21 or pour out the liquid in the water storage cavity 21.

In one embodiment, in order to improve the compactness and strength of the structure of the intermediate shell 34, the intermediate shell 34 includes a front shell 31 and an intermediate bracket 33. The intermediate bracket 33 is positioned between the front shell 31 and the bottom shell 32. The front shell 31 is connected to the bottom shell 32, thereby pressing and fixing the intermediate bracket 33. The fifth installation groove 324 and the moving cavity 331 are surrounded and formed by the intermediate bracket 33 and the bottom shell 32.

In one embodiment, the liquid adding mechanism 7 includes an installation seat 72 and a liquid bottle 71. The liquid storage cavity 711 is positioned in the liquid bottle 71, and the second magnetic attraction member 44 is arranged at a top portion of the installation seat 72. The installation seat 72 is provided with a sixth installation groove 721 used for installation of the liquid bottle 71. The installation seat 72 is provided with a liquid adding channel 726. The liquid adding channel 726 is in communication with the liquid storage cavity 711. The liquid bottle 71 is at least partially disposed in the sixth installation groove 721. The intermediate shell 34 is provided with a liquid inlet hole 311. The liquid inlet hole 311 is in communication with the water storage cavity 21. The liquid inlet hole 311 is in communication with the liquid adding channel 726 when the liquid adding mechanism 7 is installed at a bottom portion of the water tank 20. The liquid bottle 71 is equipped with a blocking member 712 for blocking the liquid storage cavity 711 from the liquid adding channel 726. The liquid adding channel 726 is in communication with the liquid storage cavity 711 when the blocking member 712 is subjected to an external force. Specifically, the liquid bottle 71 can be an existing press type bottle on the market, that is, the blocking member 712 is the pump body 14 of the press type bottle. An outlet of the pump body 14 of the bottle is in communication with the liquid adding channel 726. In this way, when the user presses a bottom portion of the liquid bottle 71, the pump body 14 is pressed. At this time, the outlet of the pump body 14 of the bottle is in communication with the liquid adding channel 726, so as to realize the oral cleaning liquid in the liquid storage cavity 711 entering the water storage cavity 21 through the liquid adding channel 726 and the liquid inlet hole 311, and mixing with the liquid in the water storage cavity 21. In other embodiments, the liquid adding mechanism 7 can also be an oral cleaning liquid capsule disclosed in patent number 202411068137.0, and the liquid adding channel 726 is equivalent to a connecting channel described in the patent. Based on this structure, when the user presses the liquid bottle 71, the oral cleaning liquid can also enter the water storage cavity 21 through the liquid adding channel 726 and the liquid inlet hole 311.

Of course, in other embodiments, the water tank 20 can also be partially sleeved on an outer side of the main unit 1, and the water tank 20 is slidable relative to the outer side of the main unit 1. That is, when the oral irrigator 100 is not in use in this embodiment, the water tank 20 is sleeved on the outer side of the main unit 1 as much as possible, so as to reduce a volume of the oral irrigator 100 in this embodiment and facilitate storage and carrying. Moreover, in this embodiment, when the oral irrigator 100 is used, the water tank 20 is slidable relative to the main unit 1 along a direction away from the liquid outlet 15, thereby increasing a space of the water storage cavity 21.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. An oral irrigator, comprising:
an oral irrigator main body, wherein the oral irrigator main body is provided with a water storage cavity for storing water and a liquid outlet;
a liquid adding mechanism detachably provided on the oral irrigator main body, wherein the liquid adding mechanism is provided with a liquid storage cavity for storing oral cleaning liquid;
when the liquid adding mechanism is assembled to the oral irrigator main body, the liquid storage cavity is in communication with the water storage cavity; and liquid in the liquid storage cavity is configured for transferring the oral cleaning liquid to the water storage cavity when a user operates the liquid adding mechanism or a main unit;
a magnetic attraction mechanism, wherein the magnetic attraction mechanism is configured for attracting the liquid adding mechanism to the oral irrigator main body when the liquid adding mechanism is close to the oral irrigator main body;
locking buckles, wherein the locking buckles are configured for locking the liquid adding mechanism onto the oral irrigator main body; and
release mechanisms, wherein the release mechanisms are configured for driving the locking buckles to move when the user operates, so that the locking buckles release connection between the liquid adding mechanism and the oral irrigator main body; and the release mechanisms are also configured for driving the locking buckles to return to an initial state when the user releases the operation.

2. The oral irrigator according to claim 1, wherein the magnetic attraction mechanism comprises first magnetic attraction members and second magnetic attraction members; the second magnetic attraction member is attracted with the first magnetic attraction member; the first magnetic attraction member is arranged on the oral irrigator main body; and the second magnetic attraction member is arranged on the liquid adding mechanism.

3. The oral irrigator according to claim 2, wherein a first installation groove is defined in the oral irrigator main body for accommodating the liquid adding mechanism; and the liquid adding mechanism is placed in the first installation groove when assembled with the oral irrigator main body.

4. The oral irrigator according to claim 3, wherein the magnetic attraction mechanism further comprises first elastic members arranged on the oral irrigator main body; the first elastic member is configured for pushing the first magnetic attraction member to move when the locking buckle releases the connection between the liquid adding mechanism and the oral irrigator main body; and when the first magnetic attraction member moves, the liquid adding mechanism is at least partially pushed out of the first installation groove through the second magnetic attraction member.

5. The oral irrigator according to claim 4, wherein the magnetic attraction mechanism further comprises a pushing block; the oral irrigator main body is provided with moving cavities and a first passing hole; the moving cavity is used for limiting a position of the pushing block; the first passing hole is in communication with both the moving cavity and the first installation groove; the first magnetic attraction member is arranged on the pushing block; the pushing block is provided with a second installation groove for accommodating the first elastic member; a position limiting convex block is provided on a peripheral side of the pushing block; the position limiting convex block is placed inside the moving cavity; the pushing block is placed in the first passing hole; and the first elastic member is at least partially placed in the second installation groove.

6. The oral irrigator according to claim 5, wherein a third installation groove is also defined in the pushing block; and the first magnetic attraction member is provided in the third installation groove.

7. The oral irrigator according to claim 6, wherein a second passing hole is defined in the pushing block; an upper end and a lower end of the second passing hole are respectively in communication with the second installation groove and the third installation groove.

8. The oral irrigator according to claim 5, wherein fourth installation grooves are defined in the liquid adding mechanism; and the second magnetic attraction member is at least partially placed in the fourth installation groove;
positioning convex blocks are provided on the liquid adding mechanism; the fourth installation groove is positioned in the positioning convex block; a positioning groove is defined in the oral irrigator main body; the first passing hole is positioned in a bottom portion of the positioning groove; and the positioning convex block is placed in the positioning groove when the liquid adding mechanism is assembled with the oral irrigator main body.

9. The oral irrigator according to claim 1, wherein a total number of the magnetic attraction mechanisms is two; and the two magnetic attraction mechanisms are spaced apart.

10. The oral irrigator according to claim 3, wherein the oral irrigator main body is provided with a guiding strip on a side wall of the first installation groove; the guiding strip extends along a direction in which the liquid adding mechanism is installed in the first installation groove; an outer side of the liquid adding mechanism is provided with a guiding groove used in conjunction with the guiding strip; and the guiding strip is placed in the guiding groove when the liquid adding mechanism is installed in the first installation groove.

11. The oral irrigator according to claim 3, wherein a fifth installation groove is defined in the oral irrigator main body; the locking buckle is rotatably provided on the oral irrigator main body; the locking buckle is at least partially placed in the fifth installation groove; an engaging block is provided on the locking buckle; a third passing hole is defined in the oral irrigator main body; the third passing hole is in communication with the first installation groove; locking openings are defined in outer side walls of the liquid adding mechanism; when the locking buckle locks the oral irrigator main body and the liquid adding mechanism, the engaging block passes through the third passing hole and then is placed inside the locking opening;
the release mechanism comprises a second elastic member and a pressing member; the pressing member is disposed on the oral irrigator main body; two ends of the second elastic member respectively abut against a side wall of the fifth installation groove, and the locking buckle; the second elastic member is positioned on one side of the locking buckle away from the pressing member; the locking buckle rotates when the pressing member is pressed, so that the engaging block is disengaged from the locking opening; and an avoidance hole for avoiding the pressing member is defined in an outer side wall of the oral irrigator main body.

12. The oral irrigator according to claim 11, wherein the release mechanism further comprises a third elastic member arranged in the fifth installation groove; a support portion is arranged in the third installation groove; and two ends of the third elastic member respectively abut against the pressing member and the support portion.

13. The oral irrigator according to claim 12, wherein two sides of the locking buckle are each provided with a rotating shaft portion; a support shaft hole is defined in the support portion; the rotating shaft portion is placed inside the support shaft hole; and the second elastic member is positioned above the rotating shaft portion.

14. The oral irrigator according to claim 10, wherein the first installation groove is positioned in a bottom portion of the oral irrigator main body; a groove opening of the first installation groove faces the bottom portion of the oral irrigator main body; a bottom surface of the engaging block is a guiding surface; and the guiding surface is used for providing a guiding effect when the liquid adding mechanism is installed in the first installation groove, so that the locking buckle rotates to drive the engaging block to move along a direction away from the liquid adding mechanism.

15. The oral irrigator according to claim 10, wherein a stop block is provided at a bottom portion of the locking buckle; the oral irrigator main body is provided with an abutting block formed below the first passing hole; and when in a locked state, the stop block abuts against the abutting block to make the locking buckle stop rotating.

16. The oral irrigator according to claim 1, wherein the locking buckles and the release mechanisms are both two in number; each of the release mechanisms is arranged corresponding to one of the locking buckles; and the two locking buckles are opposite and positioned on two sides of the first installation groove.

17. The oral irrigator according to claim 11, wherein the oral irrigator main body comprises a main unit and a water tank; the water tank is arranged below the main unit; the main unit is internally provided with a circuit board, a battery, and a pump body; the battery and the pump body are electrically connected to the circuit board; the liquid outlet is arranged on the main unit; when the pump body is driven, the pump body pumps liquid in the water storage cavity and sends the liquid out from the liquid outlet; the liquid adding mechanism is detachably arranged at a bottom portion of the water tank through the locking buckle; and the water storage cavity is positioned inside the water tank.

18. The oral irrigator according to claim 17, wherein the water tank comprises:
an outer shell detachably provided on the main unit;
an intermediate shell provided on a bottom portion of the outer shell and connected to the outer shell to form the water storage cavity; and
a bottom shell provided on a bottom portion of the intermediate shell and connected to the intermediate shell to form an fifth installation groove;
wherein the first installation groove, the third passing hole, and the avoidance hole are all defined in a bottom portion of the bottom shell; when the first magnetic attraction member is attracted with the second magnetic attraction member, the first magnetic attraction member is at least partially positioned on the bottom shell; and the pressing member is disposed on the bottom shell.

19. The oral irrigator according to claim 18, wherein the intermediate shell comprises a front shell and an intermediate bracket; the intermediate bracket is positioned between the front shell and the bottom shell; the front shell is connected to the bottom shell, thereby pressing and fixing the intermediate bracket; and the fifth installation groove is surrounded and formed by the intermediate bracket and the bottom shell.

20. The oral irrigator according to claim 17, wherein the liquid adding mechanism comprises an installation seat and a liquid bottle; the second magnetic attraction member is arranged at a top portion of the installation seat; the installation seat is provided with a sixth installation groove used for installation of the liquid bottle; the installation seat is provided with a liquid adding channel; the liquid adding channel is in communication with the liquid storage cavity; the liquid bottle is at least partially disposed in the sixth installation groove; the liquid storage cavity is positioned in the liquid bottle; the liquid bottle is equipped with a blocking member for blocking the liquid storage cavity from the liquid adding channel; and the liquid adding channel is in communication with the liquid storage cavity when the blocking member is subjected to an external force.
